(19) United States
(12) Patent Application Publication
(10) Pub. No.: US 2016/0096548 A1
(43) Pub. Date: Apr. 7, 2016

(54) ELECTRIC DRIVE MOTOR MODULE

(71) Applicant: Caterpillar Inc., Peoria, IL (US)

(72) Inventors: Joseph D. Tigue, Peoria, IL (US); Vance M. Buatte, Danvers, IL (US); Jonathan M. Baumann, Hanna City, IL (US); Gregory Austin, East Peoria, IL (US); Timothy J. Schlack, Washington, IL (US)

(73) Assignee: Caterpillar Inc., Peoria, IL (US)

(21) Appl. No.: 14/503,436

(22) Filed: Oct. 1, 2014

(51) Int. Cl. B62D 11/10; B62D 55/32; H02K 7/116

(52) U.S. Cl. CPC B62D 11/10; H02K 7/116; B62D 55/32

(57) ABSTRACT

An electric drive system including an electric drive motor module. The electric drive motor module includes an electric drive planetary gear assembly, and an electric motor having a rotor shaft. The electric drive system further includes a first output member, a second output member, and a reaction member operatively associated with the rotor shaft.

### TECHNICAL FIELD

The present disclosure generally relates to an electric drive motor module, and more particularly relates to an electric drive motor module that includes a planetary gear assembly.

### BACKGROUND

Electric drive motors generally supplement or provide driving power (otherwise provided by an internal combustion engine) to help reduce emissions and increase fuel efficiency. Electric drive motors may be used in highway trucks, automobiles, or off-road work machines, such as, for example, track-type tractors. In operation, electric drive motors typically generate an output torque which is transferred to ground engaging components on a machine—such as tracks on a track-type tractor

Some machines, such as track-type tractors, generally include a differential steering arrangement that is disposed between the electric motor and the ground engaging devices on the machine. The differential steering arrangement is operable to change relative speeds of the ground engaging devices in order to steer the machine. The differential steering arrangement typically includes one or more planetary gear assemblies separate from the electric drive motor, as well as bevel or spur gears to transfer torque. However, requiring and using separate gear systems from the electric drive motor may decrease the efficiency of the electric drive motor, as well as the overall efficiency of the machine. Moreover, because conventional electric drive motors are usually connected to planetary gear sets during the installation process they require additional installation time and steps. For example, U.S. Pat. No. 5,509,491 includes a motor operatively connected to a pair of planetary gear sets associated with respective tracks.

The foregoing background discussion is intended solely to aid the reader. It is not intended to limit the innovations described herein, nor to limit or expand the prior art discussed. Consequently, the foregoing discussion should not be taken to indicate that any particular element of a prior system is unsuitable for use with the innovations described herein, nor is it intended to indicate that any element is essential in implementing the innovations described herein. The implementations and application of the innovations described in the disclosure are defined by the appended claims.

### SUMMARY

In one aspect, the present disclosure provides an electric drive system for replacing a transmission. The electric drive system includes an electric drive motor module. The electric drive motor module includes an electric drive planetary gear assembly, and an electric motor having a rotor shaft. The electric drive system further includes a first output member, a second output member, and a reaction member operatively associated with the rotor shaft.

In another aspect, the present disclosure provides a differential steering arrangement for a high drive track-type tractor. The differential steering arrangement includes a high drive frame housing for housing an electric drive motor module. The electric drive motor module includes an electric drive planetary gear assembly and an electric motor having a hollow rotor shaft, a first output member, and a second output member. The differential steering arrangement further includes a reaction member operatively associated with the hollow rotor shaft.

In yet another aspect, the present disclosure provides a method for retrofitting a high drive track-type tractor with an electric drive motor module. The method includes inserting the electric drive motor module into a frame housing. The electric drive motor module includes an electric drive planetary gear assembly, and an electric motor. Other features and aspects of this disclosure will be apparent from the following description and the accompanying drawings.

### BRIEF DESCRIPTION OF THE DRAWINGS

FIG. 1 is an isometric view of a high drive track-type tractor within which one or more embodiments of the present disclosure may be implemented;

FIG. 2A is an isometric view of an electric drive motor module in isolation;

FIG. 2B is a cross-sectional view of an electric drive motor module attached to final drive assemblies;

FIG. 3A is an isometric view of a high drive track-type tractor frame and electric drive motor module prior to assembly; and

FIG. 3B is an isometric view of a high drive track-type tractor frame and electric drive motor module after assembly.

While the disclosure is susceptible to various modifications and alternative forms, specifics have been shown by way of example in the drawings and will be described in detail below. It should be understood that the detailed description is not to limit aspects of the disclosure to the particular embodiments described. On the contrary, the disclosure covers all modifications, equivalents, and alternatives falling within the spirit and scope of the disclosure.

### DETAILED DESCRIPTION

The present disclosure relates to an electric drive motor module that includes a reduction planetary gear assembly which can be inserted into a final drive cavity of a frame housing for a high drive track-type tractor. Wherever possible the same reference numbers will be used throughout the drawings to refer to the same or like parts. Moreover, references to various elements described herein are made collectively or individually when there may be more than one element of the same type. However, such references are merely exemplary in nature. Accordingly, it may be noted that any such reference to elements in the singular is also to be construed to relate to the plural and vice-versa without limiting the scope of the disclosure to the exact number or type of such elements unless set forth explicitly in the appended claims.

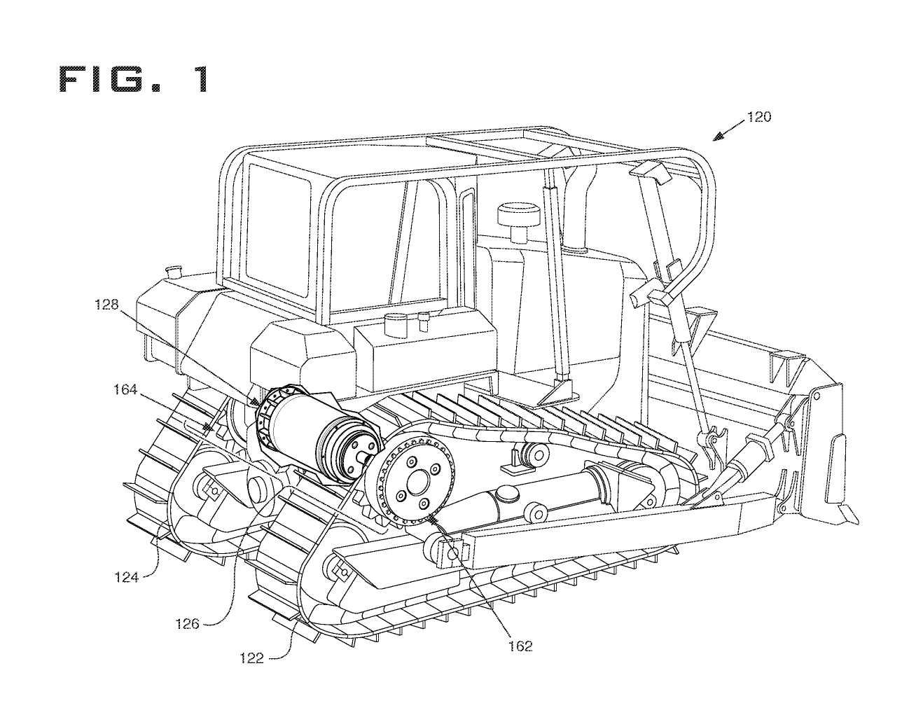

FIG. 1 shows an isometric view of a high drive track-type tractor 120 within which one or more embodiments of the present disclosure may be implemented. As shown, track-type tractor 120 includes a differential steering arrangement referred to as electric drive system 126 operatively associated with a first track 122 and a second track 124. Electric drive system 126 includes electric drive motor module 128 operatively associated with first final drive assembly 164 and second final drive assembly 162. Track-type tractor 120 may include an electrical power source (not shown) that may be, for example, a battery or an engine—such as an internal combustion engine with a generator.

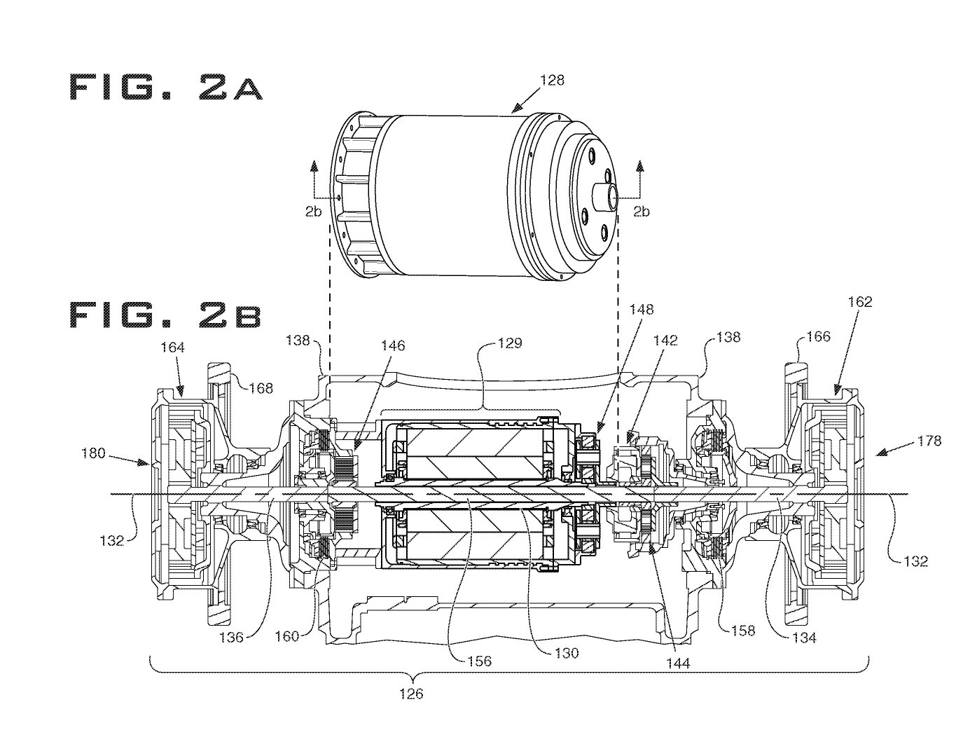

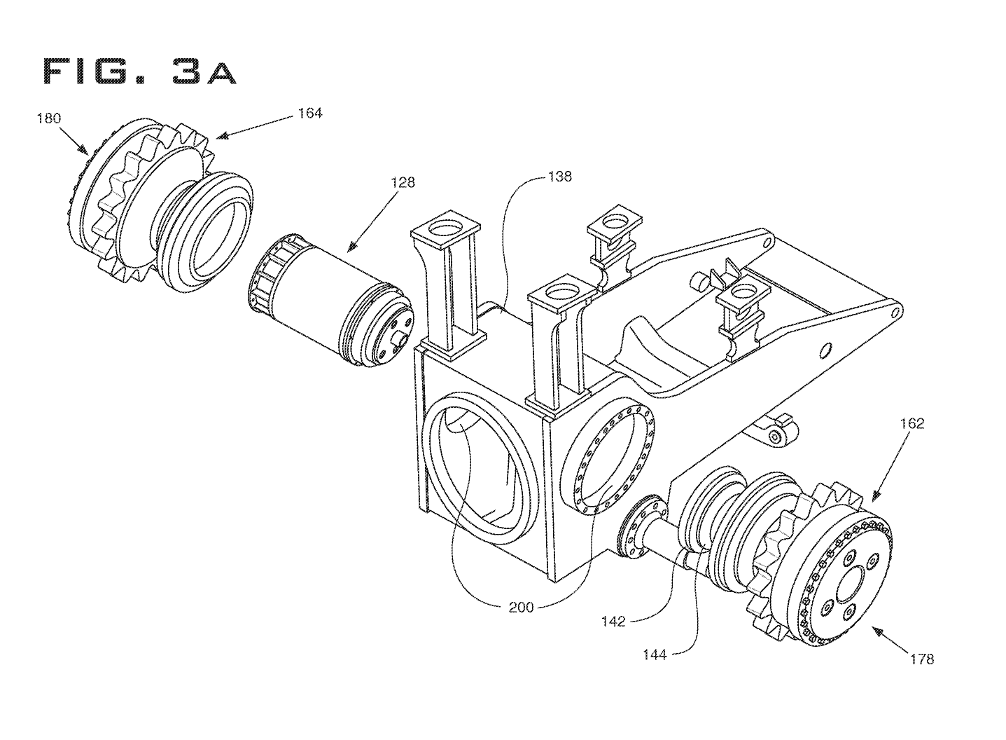

Referring now to FIGS. 2A and 2B, electric drive motor module 128 includes electric motor 129 that exerts a torque to rotate rotor shaft 130. In some embodiments, electric drive motor module 128 includes a switched reluctance electric motor (“SRM”)—shown as electric motor 129. In other embodiments, electric motor 129 is a direct current electric motor. In yet other embodiments, electric motor 129 is an alternating current motor. As electric motor 129 exerts torque, rotor shaft 130 is configured to rotate about an axis of rotation that aligns with a reference axis 132. The magnitude and direction of the exerted torque depends upon the magnitude and polarity of the electrical power that is applied to electric motor 129.

Electric drive system 126 also includes a first output member 134 and a second output member 136 that provides for differential steering. First output member 134 being operatively connected to first track 122. Second output member 136 being operatively connected to second track 124. Electric drive system 126 may further include a first sprocket 166 and a second sprocket 168. First sprocket 166 may be connected to first output member 134 and configured to engage first track 122. Second sprocket 168 may be connected to second output member 136 and configured to engage second track 124. First sprocket 166 and second sprocket 168 drive the first track 122 and the second track 124 (respectively) in response to rotation of first output member 134 and second output member 136.

A first brake 158 may be configured to engage first output member 134 and a second brake 160 may be configured to engage second output member 136. First brake 158 and second brake 160 may be operated to reduce the rotational speed of first output member 134 and second output member 136, respectively. Accordingly, first brake 158 and second brake 160 may be operated to reduce the overall speed of track-type tractor 120. First brake 158 and second brake 160 may also engage first output member 134 and second output member 136 to help prevent track-type tractor 120 from moving.

As shown in FIGS. 2A and 2B, first planetary gear assembly 142, second planetary gear assembly 144, and third planetary gear assembly 146 are all part of the differential steering arrangement. A differential steering motor (not shown) drives second planetary gear assembly 144 to create differential speed for steering by speeding up or slowing down second planetary gear assembly 144 relative to first planetary gear assembly 142. As would be understood by a person having ordinary skill in the art, the differential steering motor may be electric or hydraulic. Electric drive motor module 128 includes reduction planetary gear assembly 148 also referred to as electric drive planetary gear assembly 148. The rotation of the third planetary gear assembly 146 and electric drive planetary gear assembly 148 align with reference axis 132 and rotor shaft 130. As would be understood by a person having ordinary skill in the art, third planetary gear assembly 146 may include a sun gear, a planet gear set, and a ring gear, or a similar configuration. Likewise, as would be understood by a person having ordinary skill in the art, electric drive planetary gear assembly 148 may include a sun gear, a planet gear set, and a ring gear, or a similar configuration.

Separate from the electric drive motor module 128, electric drive system 126 includes a first planetary gear assembly 142 and a second planetary gear assembly 144. The rotation of first planetary gear assembly 142 and second planetary gear assembly 144 align with reference axis 132 rotor shaft 130. As would be understood by a person having ordinary skill in the art, first planetary gear assembly 142 and second planetary gear assembly 144 may include a sun gear, a planet gear set, and a ring gear, or a similar configuration. In combination with first planetary gear assembly 142 and second planetary gear assembly 144, the electric drive motor module 128 provides for differential steering of high drive track-type tractor 120.

A reaction member 156 operatively connects first planetary gear assembly 142 to second planetary gear assembly 144, first output member 134, second output member 136, third planetary gear assembly 146, and electric drive planetary gear assembly 148. Rotor shaft 130 may be hollow and include an opening through which reaction member 156 extends such that rotor shaft 130 and reaction member 156 substantially align with reference axis 132. Such a configuration allows the rotor shaft 130 to operatively engage with first output member 134 and second output member 136. A person having ordinary skill in the art would recognize that first planetary gear assembly 142, second planetary gear assembly 144, third planetary gear assembly 146, and electric drive planetary gear assembly 148 may have a variety of gear reduction ratios, depending upon the expected operating conditions of track-type tractor 120.

A second final drive assembly 162 may be operatively associated with first output member 134 and first sprocket 166. A first final drive assembly 164 may be operatively associated with second output member 136 and second sprocket 168. As would be understood by a person having ordinary skill in the art, second final drive assembly 162 and first final drive assembly 164 may be planetary gear assemblies that include a sun gear, a planet gear set, and a ring gear. The rotational axis of second final drive assembly 162 and first final drive assembly 164 may substantially align with reference axis 132. Second final drive assembly 162 and first final drive assembly 164 may provide a gear reduction between the first output member 134 and second output member 136, as well as first sprocket 166 and second sprocket 168. For example, the gear reduction of second final drive assembly 162 and first final drive assembly 164 may be 5:1. However, a person having ordinary skill in the art would recognize that second final drive assembly 162 and first final drive assembly 164 may provide any gear reduction to meet the operational requirements of track-type tractor 120.

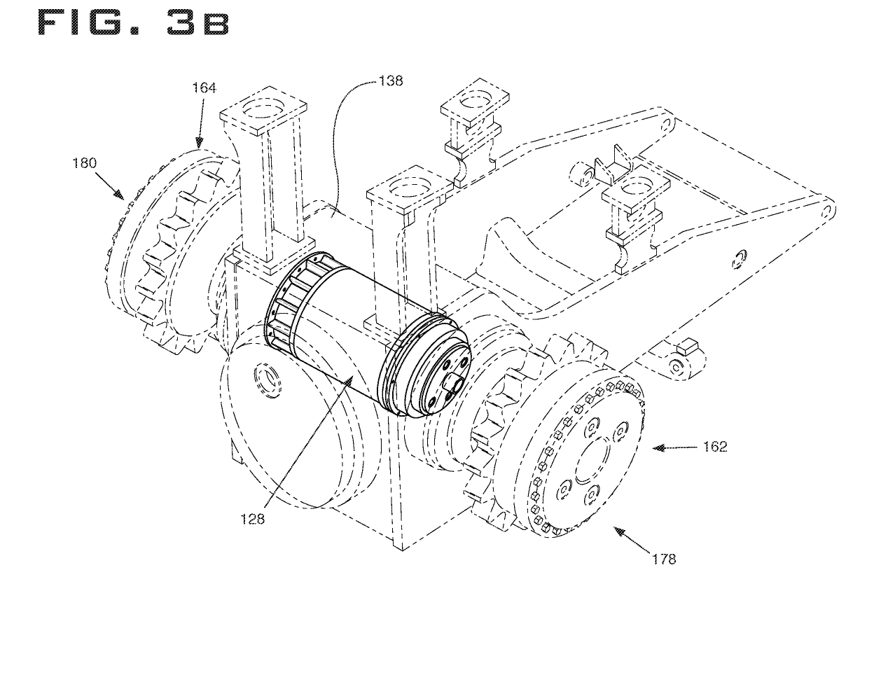

FIGS. 3A and 3B illustrate an exemplary configuration of electric drive motor module 128 within a frame housing 138. First planetary gear assembly 142, second planetary gear assembly 144, and second final drive assembly 162 may be installed in frame housing 138 from a first side 178. First final drive assembly 164 and electric drive motor module 128 may be installed from second side 180. A method for retrofitting a high drive track-type tractor 120 with electric drive motor module 128 may include inserting the electric drive motor module 128 into frame housing 138. As discussed above, the electric drive motor module 128 may include electric drive planetary gear assembly 148, and electric motor 129. The electric drive motor module 128 may be inserted into the frame housing 138 through the first side 178 of the frame housing 138 or through the second side 180 of the frame housing 138 depending on the orientation of frame housing 138. The method may also include connecting the first final drive assembly 164 and second final drive assembly 162 to the electric drive motor module 128. The method may yet further include attaching the reaction member 156 to the electric drive motor module 128 in the manner described above. Similarly, the method may include attaching the other components in the manner described above.

Although the present disclosure discloses that the electric drive motor module 128 is part of high drive track-type tractor 120, a person having ordinary skill in the art will appreciate that electric drive motor module 128 may be beneficially implemented with other similar machines. Therefore, various combinations of the parts disclosed herein may be contemplated and such combinations can be implemented without deviating from the spirit of the present disclosure.

### INDUSTRIAL APPLICABILITY

The electric drive motor module 128 of the present disclosure has applicability for implementation and use in industrial settings such as mining, agriculture, and construction. The technology described may be provided for high drive track-type tractors 120, but also may be applied to other machines—more particularly to other tracked machines having differential steering. Track-type tractor 120 may include an internal combustion engine or an electrical storage device that supplies electrical power to electric drive motor module 128. Electronic controls may govern the generation and/or supply of electrical power to electric drive motor module 128 in response to instructions from an operator. In response to electric power, electric motor 129 exerts a torque on rotor shaft 130.

The magnitude and polarity of the electrical power applied to the electric motor 129 determines the direction and magnitude of the torque exerted on rotor shaft 130. The torque exerted by electric motor 129 causes rotor shaft 130 to rotate. Rotor shaft 130 splines into electric drive gear assembly 148. Electric drive gear assembly 148 splines into first planetary gear assembly 142. First planetary gear assembly 142 drives reaction member 156. Reaction member 156 drives third planetary gear assembly 146 which drives second output member 136 that drives first final drive assembly 164 that drives second sprocket 168.

During straight driving, first planetary gear assembly 142 operates at the same speed as second planetary gear assembly 144. Second planetary gear assembly 144 drives into first output member 134 that drives second final drive assembly 162 that drives first sprocket 166. To steer track-type tractor 120, second planetary gear assembly 144 is driven by differential steering motor (not shown) which makes first output member 134 spin faster or slower than second output member 136. The rotational speed of rotor shaft 130 may be altered by electric drive planetary gear assembly 148 and third planetary gear assembly 146 located within electric drive motor module 128. The rotational speed of rotor shaft 130 also may be altered by first planetary gear assembly 142 and second planetary gear assembly 144 located outside of electric drive motor module 128. The coordination between third planetary gear assembly 146, electric drive planetary gear assembly 148, first planetary gear assembly 142, second planetary gear assembly 144, rotor shaft 130, and reaction member 156 provides for differential steering within electric drive system 126. The turning rate of track-type tractor 120 is influenced by the magnitude of the difference in relative speeds of first track 122 and second track 124. As discussed above, the present invention provides an electric drive system 126 in which the rotational axis of an electric motor 129 substantially aligns with the rotational axis of third planetary gear assembly 146, electric drive planetary gear assembly 148, first planetary gear assembly 142, and second planetary gear assembly 144. By aligning the rotational axes, the output torque of electric motor 129 may be delivered directly to third planetary gear assembly 146, electric drive planetary gear assembly 148, first planetary gear assembly 142, second planetary gear assembly 144 without the need for a bevel or spur gear transfer arrangement. Such a configuration provides for a reduction in gear losses associated with transferring torque from the electric motor 129 to first track 122 and second track 124. Accordingly, the electric drive system 126, including electric drive motor module 128, increases the efficiency of track-type tractor 120. Configuring electric drive system 126 in the manner described herein, further reduces the overall size and weight of electric drive system 126 to help reduce emissions and increase fuel efficiency by reducing overall size and weight. The electric drive motor module 128 further increases manufacturing capabilities by including at least one planetary gear within the electric drive motor module 128. Moreover, adding to the manufacturing capabilities, the electric drive motor module 128 is configured to insert into the final drive cavity 200 of frame housing 138.

While aspects of the present disclosure have been particularly shown and described with reference to the embodiments above, it will be understood by those skilled in the art that various additional embodiments may be contemplated by modification of the disclosed machines, systems and methods without departing from the spirit and scope of what is disclosed. Such embodiments should be understood to fall within the scope of the present invention as determined based upon the claims below and any equivalents thereof.

What is claimed is:

1. An electric drive system, comprising:
an electric drive motor module including:
an electric drive planetary gear assembly; and
an electric motor having a rotor shaft;
a first output member;
a second output member; and
a reaction member operatively associated with the rotor shaft.

2. The electric drive system of claim 1, wherein the electric drive motor module is operatively associated with a first planetary gear assembly, a second planetary gear assembly, and a third planetary gear assembly.

3. The electric drive system of claim 2, wherein the reaction member drives the third planetary gear assembly.

4. The electric drive system of claim 1, wherein the electric motor is an alternating current electric motor.

5. The electric drive system of claim 1, wherein the electric motor is a direct current electric motor.

6. The electric drive system of claim 1, wherein the rotor shaft splines into the electric drive planetary gear assembly.

7. The electric drive system of claim 6, wherein the rotor shaft of the electric motor is hollow and the reaction member extends through the hollow rotor shaft.

8. A differential steering arrangement for a high drive track-type tractor, comprising:
a high drive frame housing for housing an electric drive motor module, wherein the electric drive motor module includes an electric drive planetary gear assembly and an electric motor having a hollow rotor shaft;
a first output member;
a second output member; and
a reaction member operatively associated with the hollow rotor shaft.

9. The differential steering arrangement of claim 8, wherein the electric drive motor module is operatively associated with a first planetary gear assembly, a second planetary gear assembly, and a third planetary gear assembly.

10. The differential steering arrangement of claim 9, wherein the reaction member drives the third planetary gear assembly.

11. The differential steering arrangement of claim 8, wherein the electric motor is an alternating current electric motor.

12. The differential steering arrangement of claim 8, wherein the electric motor is a direct current electric motor.

13. The differential steering arrangement of claim 8, wherein the rotor shaft splines into the electric drive gear assembly.

14. The differential steering arrangement of claim 13, wherein the reaction member extends through the hollow rotor shaft.

15. A method for retrofitting a high drive track-type tractor with an electric drive motor module, comprising:
inserting the electric drive motor module into a frame housing, wherein the electric drive motor module includes an electric drive planetary gear assembly, and an electric motor.

16. The method of claim 15, wherein the electric motor includes a hollow rotor shaft that splines into the electric drive planetary gear.

17. The method of claim 15, wherein inserting the electric drive motor module into the frame housing comprises inserting the electric drive motor module through a first side of the frame housing.

18. The method of claim 15, wherein inserting the electric drive motor module into the frame housing comprises inserting the electric drive motor module through a second side of the frame housing.

19. The method of claim 15, wherein the electric motor is an alternating current electric motor.

20. The method of claim 15, wherein the electric drive planetary gear assembly splines into a first planetary gear assembly.
